(19) United States
(12) Patent Application Publication
(10) Pub. No.: US 2007/0293793 A1
(43) Pub. Date: Dec. 20, 2007

(54) System and method for simultaneously applying a plurality of therapeutic modalities to treat carpal tunnel syndrome

(76) Inventor: Scot L. Johnson, Lutz, FL (US)

Correspondence Address: MCANDREWS HELD & MALLOY, LTD, 500 WEST MADISON STREET, SUITE 3400, CHICAGO, IL, 60661, US

(21) Appl. No.: 11/811,484

(22) Filed: Jun. 11, 2007

Related U.S. Application Data
(60) Provisional application No. 60/812,661, filed on Jun. 9, 2006.

(51) Int. Cl. A61H 1/00

(52) U.S. Cl. 601/15; 601/21; 601/DIG. 3; 601/DIG. 5

(57) ABSTRACT

Embodiments of the present invention provide a system and method for delivering a plurality of modalities for the treatment of Carpal Tunnel Syndrome. Light therapy is applied to the carpal tunnel region of the hand during alternating periods of automated carpal bone structure extensions, whereby said light therapy penetrates beyond the bone structures to the carpal (volar and transverse) ligament structures, median nerve, and muscles. The light therapy is applied both above and below these structures. Simultaneously applied electrical stimulation may occurs between electrodes located both above and below various positions about the carpal tunnel region. Both light therapy and electrical stimulation are positioned optimally to affect the carpal tunnel via automated structures that provide continuous feedback to a control system. The automated structures also stimulate the flow of blood and movement of fluids associated with pressure inducing edema through the carpal tunnel region.

### RELATED APPLICATION

This application claims the benefit of U.S. Provisional Application No. 60/812,661, filed Jun. 9, 2006, which is incorporated herein by reference in its entirety.

### BACKGROUND OF THE INVENTION

Embodiments of the present invention generally relate to the treatment of carpal tunnel syndrome, and more particularly to a system and method for simultaneously applying a plurality of therapeutic modalities to treat carpal tunnel syndrome.

Carpal Tunnel Syndrome affects a wide demographic of the population. Occupational hazards such as typing in offices, performing mechanical operations repetitively, and carrying of heavy loads create repetitive stress injuries in the joint structures of the wrist and hand. These stresses irritate and inflame the carpal ligaments (both volar and transverse), as well as tendons and tissues between the ulna and radius bones of the forearm and the metacarpals. This inflammation leads to edema and swelling, which puts pressure on neural pathways (median nerve and to a lesser extent the ulnar nerve), as well as blood flow structures (radial artery and to a lesser extent the ulnar artery). The condition is painful, causes inflamed regions and pockets of fluid that decrease mobility, and diminishes nerve signal conduction resulting in a loss of control of the hand and finger structures. Carpal Tunnel Syndrome is progressive. As irritation, edema, and inflammation increase, numbness, pain, tingling sensations in the hand and digits and general swelling increase. The condition can progress such that neural scarring occurs, further decreasing nerve conduction.

Once the condition has produced sufficient neural scarring, invasive procedures are utilized to treat the patient. These procedures include releasing (severing) the transverse and possibly volar carpal ligaments, and additionally in some cases scraping away scar tissue.

Patients who seek intervention prior to the need for invasive procedures may receive manually applied physical therapy. These therapies are designed to non-invasively increase the mobility of the nerve structures of the carpal tunnel region. They are also designed to move fluids through the region, decreasing edema and pressure. Light therapy, including light sources such as lamps, light emitting diodes (LEDs), and “cold” lasers, may be applied to specific points for definite periods of time in an effort to increase local healing functions and reduce inflammation. In some cases, a carpal strap is applied about the carpal tunnel region between the metacarpals and the ulna and radius bones of the forearm. This strap is tightened such that pressures applied perpendicular to the flat of the hand press the carpal bones (including the harnate, capitate, trapeziod, trapezium, scaphoid, and lunate). This action deepens the carpal tunnel in an effort to increase the carpal tunnel space and relieve pressure on the median nerve. This action also decreases the stress on the transverse and volar ligaments. Patients are typically instructed to wear a wrist splint, which immobilizes the wrist, reducing further irritation through movement of the structures during periods throughout the day. A patient's daily activities may be assessed for causes of the irritation. More ergonomic methods may be suggested for activities which incite and irritate the carpal tunnel region. Finally, TENS units may be applied and additionally issued to patients for the reduction of pain and ability to increase cellular functions related to healing.

Exercises, both those with and without the assistance of a healthcare provider, are dependent upon technique and may vary from application to application. As well, exercises assisted by a healthcare provider require one-on-one time which is increasingly difficult to schedule as the number of patients exhibiting symptoms of carpal tunnel Syndrome increases.

Light therapy via cold laser therapy requires knowledgeable application by a healthcare professional and is point dependent—again placement of the laser can vary from application to application. Cold laser therapy covers only a small region of the carpal tunnel, resulting in the need for repeated applications. Additionally the wavelength of the laser is finite by the nature of the technology—it has been demonstrated that wavelengths between 790 nm and 870 nm are preferable for the treatment of inflammation and increased cellular function. Cold laser instruments are also expensive and require safety goggles to protect patient and healthcare provider vision. Light Therapy from lamps and LEDs can be applied about the carpal region. Flexible light pads containing lamps and LEDs provide heat and general light. In both cold laser and non-laser illumination, the carpal bones absorb and reflect a significant amount of light. As the bones block the underside of the carpal tunnel, light is typically directed around and about these structures—these methods limit the exposure of affected structures to the benefits of light therapy. As before, the one-on-one time required between patient and physician is increasingly difficult to schedule, and often a compromise between manual manipulation for mobility and some form of light therapy is required.

Carpal straps and wrist splints are affective for short periods of time and are dependent upon application. Often these devices are applied by unskilled patients, thereby limiting the effectiveness of the device.

### SUMMARY OF THE INVENTION

Certain embodiments of the present invention provide a combination of effective modalities (Light Therapy and Electrical Stimulation) simultaneously to achieve a higher degree of effectiveness relative to the time spent in the healthcare provider's facility. Further, a device that may apply these modalities in an automatic fashion, requiring limited setup by a healthcare provider, increases the number of patients who may be successfully treated. A device that automates these modalities may also manipulate the carpal tunnel region simultaneously to circulate fluids and open the carpal spaces. The automated manipulation can be designed such that the bone structures of the carpal tunnel are separated, allowing the application of light therapy to penetrate deeper beyond and around the bones that would otherwise block their delivery.

Such a device would expedite the healing process of the patient and provide an opportunity for healthcare providers to treat more patients. The majority of a healthcare provider's time could be spent performing and instructing on stretches and exercises designed to increase mobility and move edema through the affected regions, counseling the patient on the use of passive immobilization devices outside of the healthcare provider's office, and assessing and counseling patients on more ergonomic methods of utilizing the hands and wrist.

Certain embodiments of the present invention include a system for capturing and positioning the wrist and hand of a patient for the application of a plurality of therapeutic modalities. The system includes a conforming, ergonomic portion above and below the hand and wrist that positions the structures for optimal delivery of therapeutic modalities. The lower portion may remain stationary while the upper portion is automatically lowered upon the hand and wrist. Tension measuring device(s) detect pressures exerted upon the hand and wrist so as to optimize capture of the structures while limiting the possibility of cutting off circulation and placing excessive pressures on the carpal tunnel space. The hand may be placed into this structure flat, parallel to the ground.

Certain embodiments of the present invention provide a system and method of placement of therapy devices containing both light therapy and electrical stimulation components. The placement of the therapy devices are optimized such that light therapy is fixedly directed to the entirety of the carpal tunnel region extending from the ends of the ulna and radius forearm bones to just above the beginning of the metacarpals. Electrical stimulation is fixedly placed such that bipolar interferential (two pad) electrical stimulation is applied above, about, and below the carpal tunnel region. Additionally, switching mechanisms allow for electrical pad designations that convert the pain blocking bipolar interferential therapies to change to a crosswise pattern that allows quadripolar interferential therapy. The electrodes are positioned such that the epicenter of the interference pattern is located central to the carpal tunnel. This switching mechanism allows for on-the-fly adjustments for optimal therapeutic benefit.

Certain embodiments of the present invention include an automated rotation of the hand and wrist once placed and secured between the upper and lower portions of the capturing device previously described. The hand and wrist are rotated 90° outward, palm facing towards the body, perpendicular to the floor. This action places the muscles and tendons in a natural state more suited to stimulation and the application of decompressive tensile forces. The hand and wrist capturing devices and light therapy and electrical stimulation apparatus is further automated to apply decompressive tensile forces inline with the forearm, wrist and hand. These forces extend and decompress the carpal bones, allowing light therapy to penetrate from all sides of the wrist into the carpal tunnel. Decompressive tensile forces are applied logarithmically and are alternated between upper and lower tensile force plateaus. The alternation of the forces produces a pumping motion that stimulates movement of fluids through the carpal tunnel. Fluids influenced include blood supply, nourishing the wrist and hand, as well as those associated with edema, moving them through and away from the carpal tunnel.

Embodiments of the invention described above are useful in the treatment of Carpal Tunnel Syndrome (CTS) as it may arise again after invasive procedures have occurred. The system is also capable of routine application as a preventative measure for those patients who have undergone invasive procedures.

### BRIEF DESCRIPTION OF THE DRAWINGS

FIG. 1 illustrates the wrist and hand bone structure.

FIG. 2 illustrates the ligament, nerve, and artery structures of the wrist and hand associated with Carpal Tunnel Syndrome.

FIG. 3 illustrates a lower portion of a therapy housing used to contain the wrist and hand according to one embodiment of the present invention.

FIG. 4 illustrates a therapeutic system for automatically compressing a wrist and hand between the upper portion and the lower portion of the form structure according to one embodiment of the present invention.

FIG. 5 illustrates a proximal therapeutic device that is used to supply light therapy and electrical stimulation simultaneously to the hand and wrist according to one embodiment of the present invention.

FIG. 6 illustrates a distal therapeutic device that is used to supply light therapy and electrical stimulation simultaneously to the hand and wrist according to one embodiment of the present invention.

FIG. 7 illustrates a system for aligning the light and electrical stimulation of a proximal and distal therapeutic device within the lower portion of a therapy housing according to one embodiment of the present invention.

FIG. 8 illustrates a wrist and hand positioned in the lower portion of a therapy housing according to one embodiment of the present invention.

FIG. 9 illustrates a wrist and hand compressed between the upper and lower portions of a therapy housing according to one embodiment of the present invention.

FIG. 10 illustrates a rotated and compressed wrist and hand and a secured upper arm during use of a therapeutic system in accordance with one embodiment of the present invention.

FIG. 11 is a top plan view of a wrist and hand positioned between the proximal and distal therapeutic devices as they may be positioned within the therapy housing (not shown) according to one embodiment of the present invention.

FIG. 12 is a top plan view of a wrist and hand undergoing Quadripolar Interferential stimulation while positioned between proximal and distal therapeutic devices according to one embodiment of the present invention.

FIG. 13 is a top plan view of an upper and lower proximal and distal therapeutic devices positioned about a patient's wrist and hand that is undergoing Medium Frequency or Bipolar Interferential stimulation of the carpal tunnel region according to one embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

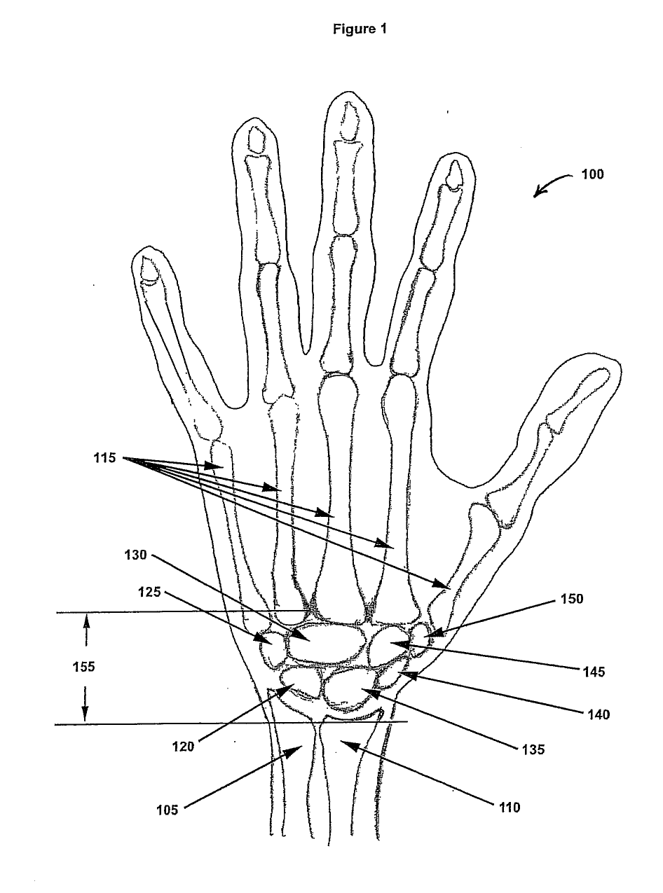

FIG. 1 illustrates the wrist and hand bone structure 100. The distal heads of the ulna forearm bone 105 and radius forearm bone 110 are shown crossing into the carpal tunnel region 155 of treatment. Although the focus of the light therapy and electrical stimulation of the present invention may be the carpal tunnel region 155, in some embodiments of the present invention the light therapy and electrical simulation may also cover areas distal and/or proximal to the carpal tunnel region 155. Distal to the carpal tunnel region 155 are the metacarpal bones 115. The proximal metacarpal bones 115 are shown included in the carpal tunnel region 155. The various bones of the wrist are all contained within the carpal tunnel region 155, and include the lunate 120, triquetral 125, capitate 130, harnate 135, scaphoid 140, trapezoid 145, and trapezium 150. The wrist bones may form the bottom and partial sides of the carpal tunnel region 155 itself. The decompressive tensile forces of the present invention seek to extend the spaces between these bones such that light therapy from a plurality of sources and types, including, but not limited to, laser, LED, and lamp, may penetrate between and into the bottom of the carpal tunnel region 155.

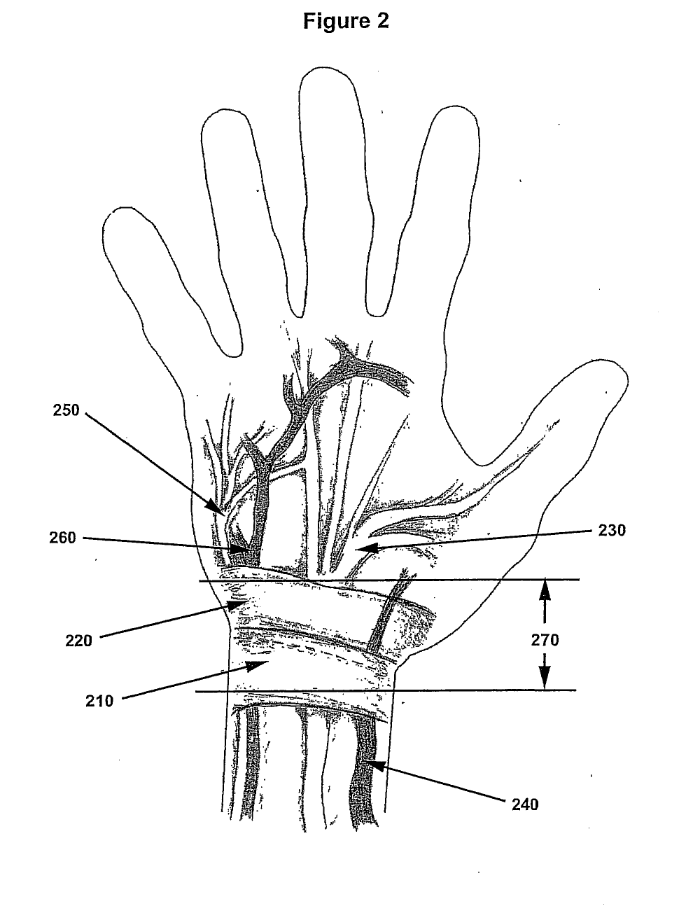

FIG. 2 illustrates the ligament, nerve, and artery structures of the wrist and hand associated with Carpal Tunnel Syndrome (CTS). The two major carpal tunnel ligaments 270 associated with CTS are the volar carpal ligament 210 and the transverse carpal ligament 220. The volar carpal ligament 210 and the transverse carpal ligament 220 may be relieved by the compressive forces of a carpal strap by exerting pressures on either side of the carpal tunnel region. Where a patient's condition indicates the need, the volar and transverse carpal ligaments 210, 220 may be cut or “released” via invasive surgeries.

Extending through and about the carpal tunnel region 155 are the nerves, such as the median nerve 230 and the ulnar nerve 250, along with arteries, such as the radial artery 240 and the ulnar artery 260, that may be associated with CTS. The median nerve 230 may run directly through the center of the carpal tunnel region and may be affected by irritation and edema associated with CTS. With the infliction of CTS, the median nerve 230 conduction velocity may be gradually diminished, which eventually may lead to neural scarring that may require invasive scraping and removal. The radial artery 240 also may run through and about the carpal tunnel region. Through irritation and edema within the carpal tunnel region, the radial artery 240 may become compressed, thereby becoming less able to deliver blood to the structures of the wrist and hand.

Secondary structures affected by CTS may include the ulnar nerve 250 and ulnar artery 260. Both the ulnar nerve 250 and ulnar artery 260 run through and about the carpal tunnel region. As discussed below, embodiments of the present invention may be configured to relieve irritation and edema related pressure on the median nerve 230, radial artery 240, ulnar nerve 250 and ulnar artery 260 by directing light therapy, electrical stimulation, and decompressive tensile force simultaneously at and about the carpal tunnel region.

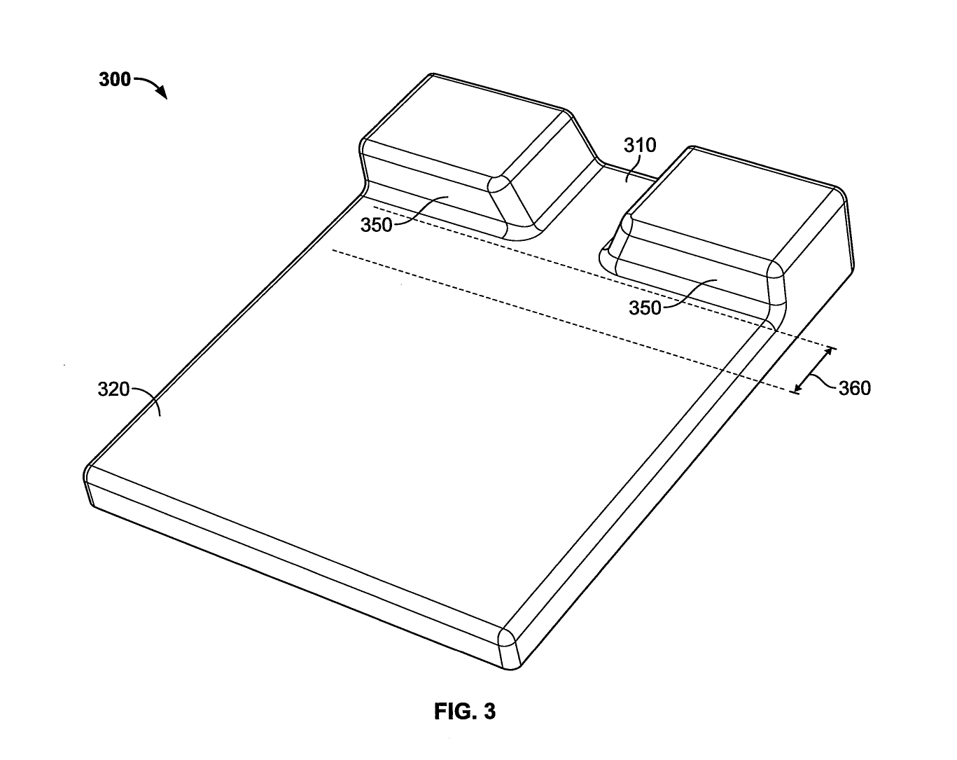

FIG. 3 illustrates a lower portion 300 of a therapy housing used to contain the wrist and hand according to one embodiment of the present invention. The therapy housing may include both a lower portion 300, as shown in FIG. 3, and an upper portion (not shown). The upper portion may or may not have a configuration similar or at least generally identical to that of the lower portion 300. Further, the lower portion 300 and the upper portion may be configured so that, when properly oriented and used in conjunction with each other, at least a portion of a patient's hand and/or wrist is enclosed by the therapy housing. Additionally, the therapy housing may be configured so as to accommodate a variety of different wrist and hand morphologies. When the upper portion and lower portion 300 of the therapy housing are in position for the therapeutic treatment of CTS, the therapy housing may also allow decompressive tensile forces to be comfortably applied to the hand and/or wrist.

In one embodiment of the present invention, the lower portion 300 of the therapy housing may be constructed with conforming foam that is built upon a rigid platform. The conforming foam may assist in attempting to evenly and comfortably distribute pressures that may be exerted on the hand and wrist when the hand and wrist are at least partially enclosed by upper portion and lower portion 300 of the therapy housing. In use, a patient's wrist may be laid into a wrist channel 310 on the lower portion 300 of the therapy housing. Wrist supports 350 may be located at either side of the wrist channel 310 so as to assist in properly positioning the hand and wrist of a patient at the desired location. The wrist supports 350 may also be configured to allow for the repeated placement of different patients' wrists in the same general location in the therapy housing. In one embodiment, the sizing and placement of the wrist supports 350 may also allow the lower portion 300 to “grab” the hand distal and at the heads of the ulna and radius forearm bones.

In one embodiment of the present invention, the wrist supports 350 may be extruded foam blocks. By constructing the wrist channel 310 primarily of conforming foam, the wrist channel 310 may be able to expand to accommodate larger wrist structures, which may thereby assist in allowing the placement of wrist and hand of many different patients in the same general location within the therapy housing.

In accordance with one embodiment of the current invention, the wrist supports 350 may extend several inches back from the heads of the ulna and radius forearm bones 105, 110, which may accommodate and seat the wrist sufficiently for therapy.

The lower portion 300 of the therapy housing may also include a carpal tunnel area 360. The carpal tunnel area 360 may be designed to exert as little compressive force from the therapy housing as possible. Therefore, according to one embodiment of the present invention, the tunnel area may be a recessed surface that is configured so as to prevent any further irritation of the patient's CTS.

The lower portion 300 of the therapy housing may also extend beyond the wrist supports 350 sufficiently far so as to seat the patient's hand. The patient's hand may lie on a hand support region 320 that may be a relatively flat area or an at least partially contoured area. The hand region 320 may include foam that may assist in at least partially distributing compressive forces exerted upon the hand by the upper portion and/or lower portion of the therapy housing as evenly and comfortably as possible.

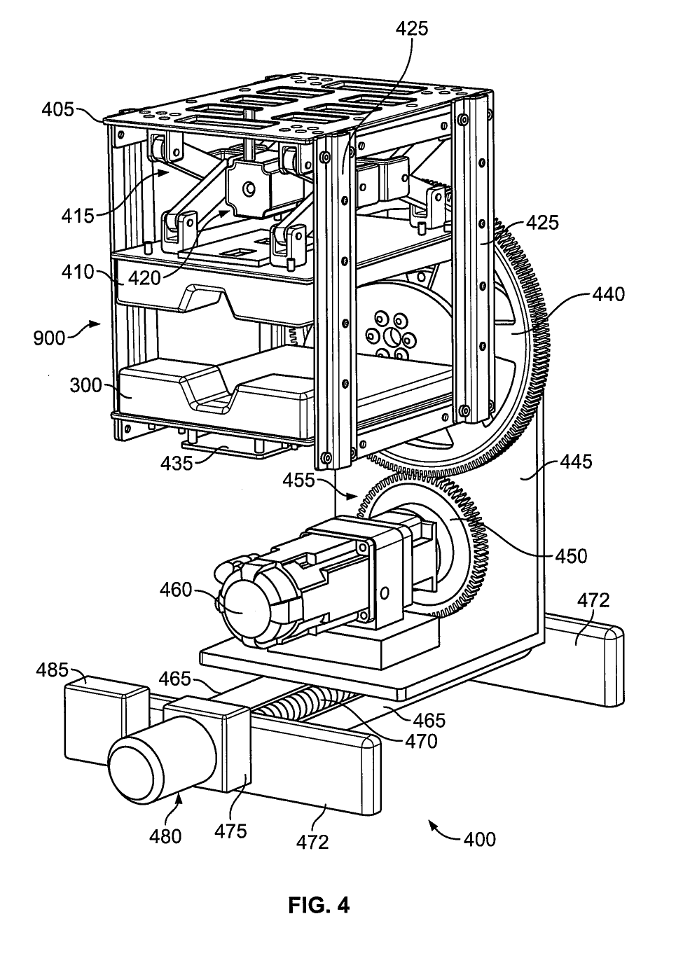

FIG. 4 illustrates a therapeutic system 400 for automatically compressing a wrist and hand between the upper portion 410 and the lower portion 300 of the therapy housing 900 according to one embodiment of the present invention. The therapeutic system 400 may include a controller 485 which receives commands from a computer that allows healthcare providers to set individual parameters for the treatment of different patients. The controller 485 may automate the lowering of the upper portion 410 of the therapy housing 900 upon the patient's hand. For example, the upper portion 410 may be lowered via a mechanical scissors apparatus 415 secured to the top of a fixed mechanical framework 405 and to the bottom of the upper portion 410 of the therapy housing 900. The mechanical scissors apparatus 415 may be extended and contracted, exacting a lowering and raising of the upper portion 410, by a rotational motor, for example a stepper motor 420. Further, the stepper motor 420 may be operated by a controller 485. In such an embodiment, the stepper motor 420 may include a threaded motor shaft screw that is rotated, thereby causing the centers of the mechanical scissors apparatus 415 to be forced outward, which results in the upper portion 410 of the therapy housing 900 to be extended downwards toward the lower portion 300 of the therapy housing 900. The upper portion 410 of the therapy housing 900 may ride along rails 425, which may smoothly deliver the upper portion 410 of the therapy housing 900 upward and downward, relative to the mechanical framework 405.

In accordance with the embodiment of the present invention illustrated in FIG. 4, in operation, a patient's wrist and hand may be seated on or against the lower portion 300 of the therapy housing 900 while the upper portion 410 may be at least partially retracted. Once the patient's wrist and hand are seated in the lower portion 300, the upper portion 410 of the therapy housing 900 may be lowered onto at least a portion of the patient's hand and/or wrist by the rotation of the stepper motor 420 threaded shaft screw and resulting extension of the mechanical scissors apparatus 415, as described above. A tension measuring device 435, for example a load cell or load button, may be located underneath the lower portion 300 of the therapy housing 900, and may provide compressive force feedback to the controller 485. Based on feedback from the tension measuring device 435, the controller 485 may continuously adjust the compression exerted on the wrist and hand by controlling the position of the upper portion 410 of the therapy housing 900 through the activation of the stepper motor 420.

In one embodiment of the present invention, once the wrist and hand are compressed between the upper and lower portions 410, 300 of the therapy housing 900, the therapy housing 900 (and the hand inserted therein) may be rotated, for example by rotation assembly that may rotate the therapy housing approximately 90 degrees outward. Rotational adjustment of the location of hand and wrist may allow for the wrist and hand of the patient to be placed at an optimal position for treatment. Any number of mechanical devices and connections may be utilized by the rotation assembly to rotate the therapy housing. For example, the rotation assembly may be comprised of chains and sprockets, belts and pulleys, or the direct coupling of a motor to the therapy housing, among others. In the embodiment illustrated in FIG. 4, this rotational adjustment may be achieved by rigidly securing the mechanical framework 405 to a large gear 440. The large gear 440 is rotationally fixed to one side of a roller bearing, which is rigidly fixed to an intermediate frame 445. The large gear 440 may be rotated in either direction by a smaller gear 450, which may be connected to the output shaft of a gearbox 455. The large gear 440, small gear 450, and gearbox 455 may provide sufficient mechanical advantage such that a small rotation motor 460 may be capable of smoothly rotating and holding in place the mechanical framework 405 of the wrist and hand capturing therapy housing 900. Suitable rotational motors 460 include, but are not limited to, a servo motor, which may receive commands from a servo amplifier located within the controller 485.

The large gear 440 may also be connected to a device that accurately records position, such as, but not limited to, a potentiometer, resolver, encoder, or absolute position sensor. The rotational sensing device may also be an absolute position sensor, which, upon device power up, relays feedback to the controller 485 of the exact position of the large gear 440 without the need to find a homing sensor and/or limit sensors. Limit sensors and mechanical stops may be positioned such that the rotation cannot exceed 90 degrees in either direction. Additionally, if the device is to only treat either the left or right wrist and hand, limit sensors and mechanical stops can be positioned to limit rotation to 90 degrees in a specific direction.

The frame 455 of the present embodiment supporting the rotation and compression devices described above may be secured to two hardened steel shafts 465 via pillow blocks located beneath it 455 figure. This may allow the frame 455 to slide linearly. Additionally a threaded mechanical screw 470 running between the steel shafts 465 may be held suspended between two lower support blocks 472. The threaded mechanical screw 470 may be free to rotate, via bearings within the support blocks 472. These support blocks 472 may also rigidly hold the steel shafting 465.

In the embodiment illustrated in FIG. 4, a small rotational motor 480 is coupled to a gearbox 475, which is coupled to the threaded mechanical screw 470. The small rotational motor 480 is operated by the controller 485. The small rotational motor 480 may be a servo motor, and may be controlled via a servo amplifier located within the controller 485. The threaded mechanical shaft 470 may be coupled to the frame 455 via an external linear nut that is rigidly fixed underneath the frame 455. As the small rotational motor 480 rotates the threaded mechanical shaft 470, the frame 455 is moved linearly forwards and backwards.

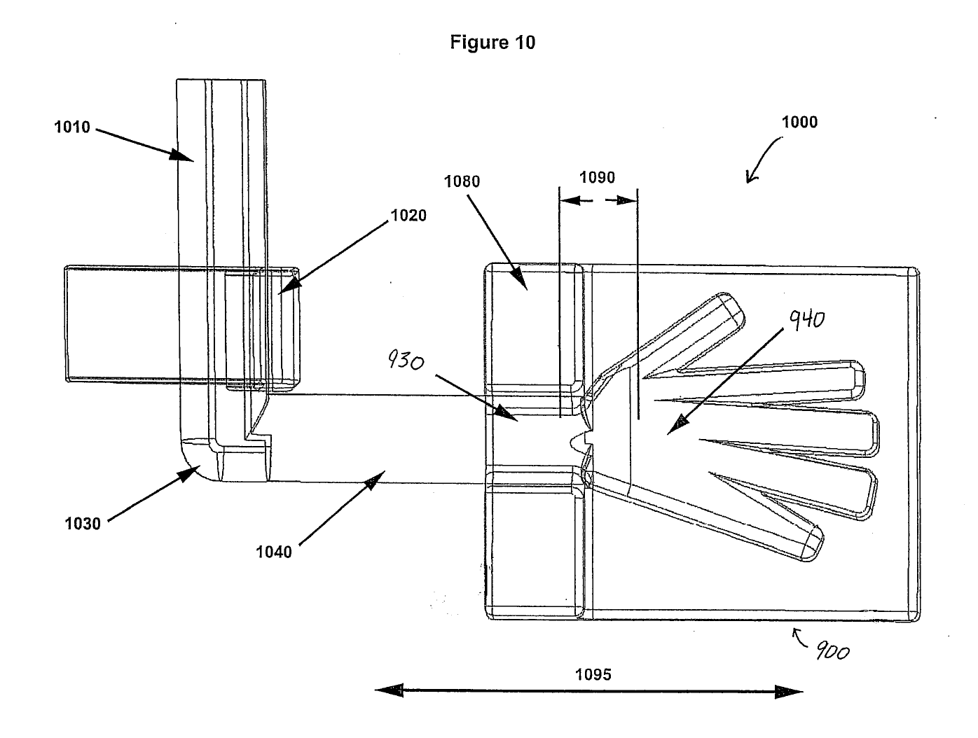

In one embodiment of the present invention in FIG. 4, the upper arm of the patient may be held in a fixed position at the level of the side of the body by an upper arm restraint, such as that shown in FIG. 10. The captured and rotated wrist and hand are moved linearly away from and back towards the elbow by the actions of the small rotational motor. As this cyclic action occurs, the bone structures of the wrist and hand are extended and retracted, affecting a cyclic unloading of said bone structions. This action decompresses the bone structures of the hand and wrist. The decompressive tensile forces described above are measured by a tension measuring device that may located within an upper arm restraining device that retains the position of the upper arm. The tensile force feedback of the upper arm restraining device may be fed back to the controller 485, which may adjust and keep safe decompressive tensile force levels.

Dual light therapy and electrical stimulation devices may be located within the upper portion 410 and/or the lower portion 300 of the therapy housing 900, which may apply simultaneous therapy to the hand and wrist. During periods of decompressive tensile force application, the controller 485 may power the light therapy devices such that light therapy is applied from above and/or below the wrist and hand. The controller 485 may also control the continuous application of electrical stimulation therapy. The decompressive tensile force may also be configured to cause a pumping action on the hand and/or wrist as it is cycled logarithmically between periods of maximum and minimum tension, thereby assisting in the movement of fluid through and about the wrist, reducing edema. Decompressive tensile forces may also promote the improvement of mobility of structures located within the carpal tunnel.

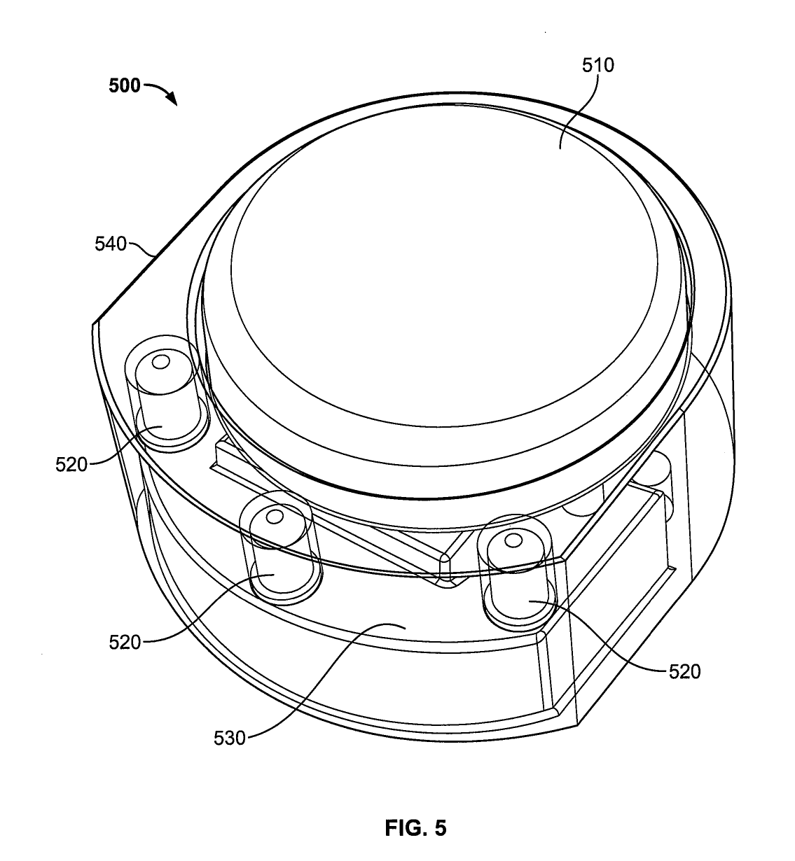

FIG. 5 illustrates a proximal therapeutic device 500 that is used to supply light therapy and electrical stimulation simultaneously to the hand and wrist according to one embodiment of the present invention. The proximal therapeutic device 500 shown may be housed in a single structure 540. Further, the proximal therapeutic device 500 may be made of a solid, optically transparent material, for example ABS plastic, that is biologically safe for application to the skin. The proximal therapeutic device 500 may include a plurality of light therapy sources 520, such as, but are not limited to, lasers, LEDs and lamps, or a combination thereof. The light therapy sources 520 may be arranged such that illumination is permitted to extend upward or downward and into the patient's carpal tunnel region. In one embodiment of the present invention, at least a portion of the light therapy sources may be positioned within the therapy housing. In such an embodiment, the light therapy sources 520 may be located nearer to the wrist, such as about and beyond the proximal heads of the metacarpals of the hand.

The proximal therapeutic device 500 shown in FIG. 5 may also include at least one electrode 510. The electrode 510 may be made of a biologically safe material, including, but not limited to, medical-grade metals, such as stainless steel, and silicon-rubber doped with such agents as carbon-black, silver, and gold, among others. Further, in one embodiment, the electrode 510 may extend upon smooth lines above the clear housing 540. The electrode 510 conducts electrical current into the hand and/or wrist and may communicate this current between any of the other wrist or hand electrodes of the present invention. In one embodiment of the present invention, the light therapy sources 520 and electrode 510 may be held rigidly in place within the clear housing 540. Further, the light therapy sources 520 and electrode 510 may be connected internally to a printed circuit board 530, which may deliver and route power to the light therapy sources 520 and electrode 510. Further, the printed circuit board 530 may be electrically connected to a controller 485.

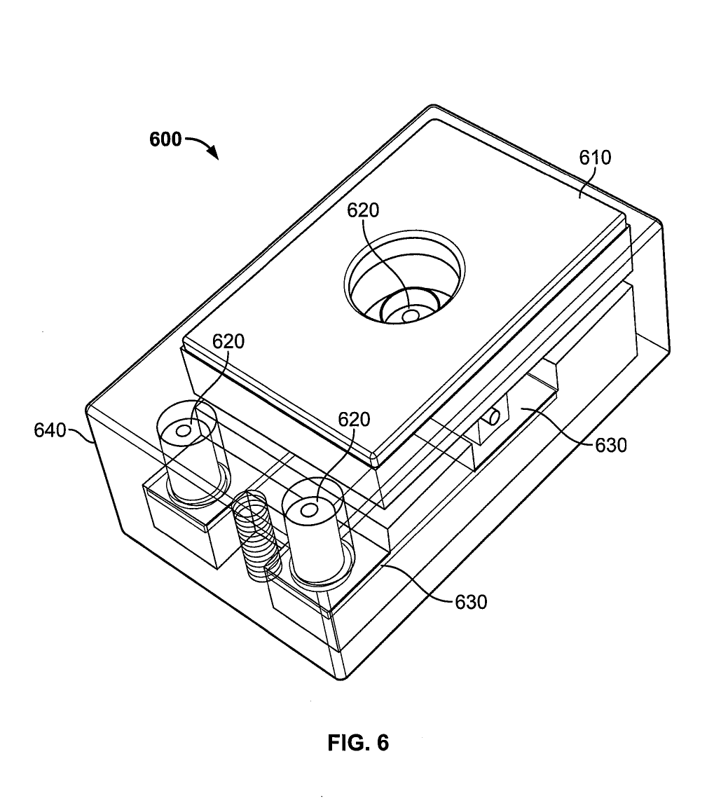

FIG. 6 illustrates a distal therapeutic device 600 that is used to supply light therapy and electrical stimulation simultaneously to the hand and/or wrist according to one embodiment of the present invention. The distal therapeutic device 600 may include a housing 640. The housing 640 may be constructed form a number of different materials, including, but not limited to, a solid, optically transparent material, such as ABS plastic, that is biologically safe for application to the skin. The housing 640 may be operably connected to a plurality of light sources 620, for example lasers, LEDs and/or lamps, arranged such that illumination is permitted to extend upward or downward and into the patient's carpal tunnel region. For example, the housing may be configured so that the light therapy is directed principally at the carpal tunnel region and secondarily to the wrist at and below the ulna and radius forearm bones. When positioned within the therapy housing, the light sources 620 may be located nearer to the wrist, about and beyond the distal heads of the ulna and radius bones of the forearm. An electrode 610 made of a biologically safe material may extend upon smooth lines above the housing 640. The electrode 610 conducts electrical current into the wrist and may communicate this current between any of the other wrist or hand electrodes of the present invention. The light sources 620 and electrode 610 may be held rigidly in place within the housing 640, and may be connected internally to a printed circuit board 630, which may deliver and route power to the light sources 620 and electrode 610. The printed circuit board 630 may be electrically connected to the controller 485.

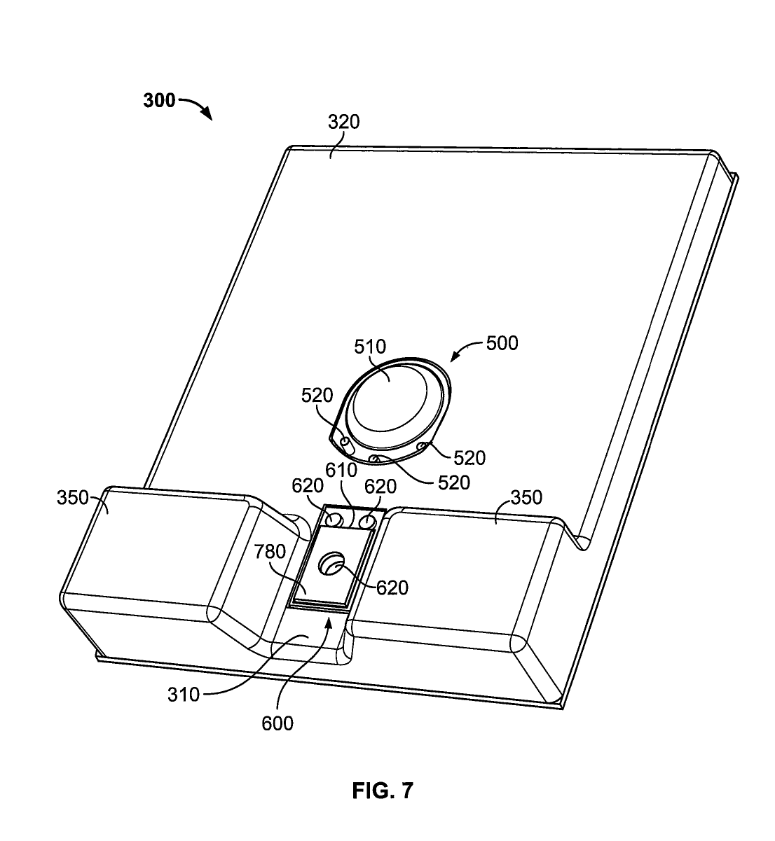

FIG. 7 illustrates a system for aligning the light therapy and electrical stimulation of proximal and distal therapeutic devices 500, 600 within the lower portion 300 of a therapy housing according to one embodiment of the present invention. The system of the present invention may be configured to allow the use or inclusion of any number of different therapeutic devices. In use, the wrist may be placed within the wrist channel 310 and the hand upon the hand support region 320 of the lower portion 300 of the therapy housing such that the distal heads of the ulna and radius forearm bones 105, 110 are contained within the wrist supports 350. The hand support region 320 of the lower portion 300 of the therapy housing may extend sufficiently to accommodate various hand and finger lengths. As shown, the carpal tunnel area 360 may extend from just before the end of the wrist supports 350 about the light therapy sources 520 of the proximal therapeutic device 500. The proximal therapeutic device 500 may direct current into the wrist through a biologically safe conductive electrode 510. As previously mentioned, light therapy may radiate into the wrist and carpal tunnel region via a plurality of light sources 520. Further, the proximal therapeutic device 500 may direct current into the hand through a biologically safe conductive electrode 770.

Light therapy may also radiate into the hand and carpal tunnel region via the distal therapeutic device 600, which may include a plurality of light sources 620 and an electrode 610. The plurality of light sources 620 and electrode 610 may be positioned within the therapy housing such that light and electrical stimulation is optimally delivered to a variety of wrist and hand morphologies. Further, the upper portion of the therapy housing may also include the same or similar therapeutic devices as those described above so that light and electrical stimulation therapy may be applied from both above and below the carpal tunnel region.

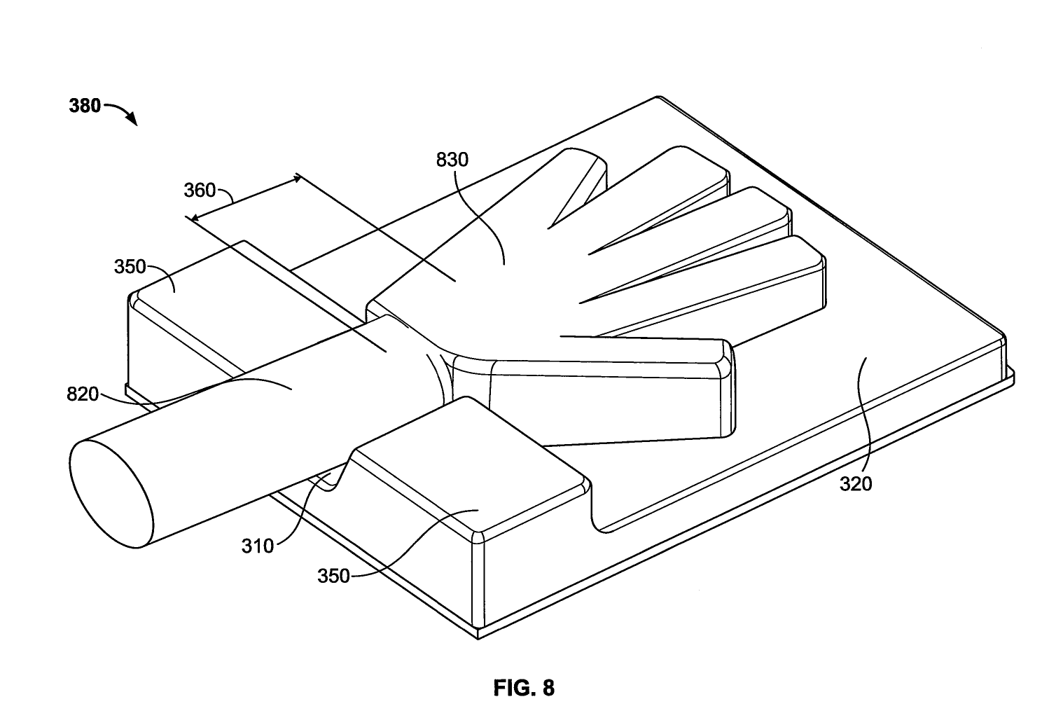

FIG. 8 illustrates a wrist 820 and hand 830 positioned in the lower portion 300 of a therapy housing according to one embodiment of the present invention. At least a portion of the wrist 820 may be placed within the wrist channel 310 and between the wrist supports 350. The hand 830 may extend beyond the wrist supports 350 and lie on the hand support region 320 of the lower portion 300 of the therapy housing. The carpal tunnel area 360 is shown as extending from approximately just above the distal heads of the ulna and radius forearm bones in the wrist 820 to approximately just below the proximal heads of the metacarpal bones of the hand 830. The proximal and distal therapeutic devices 500, 600 are located correspondingly below the wrist 820 and hand 830.

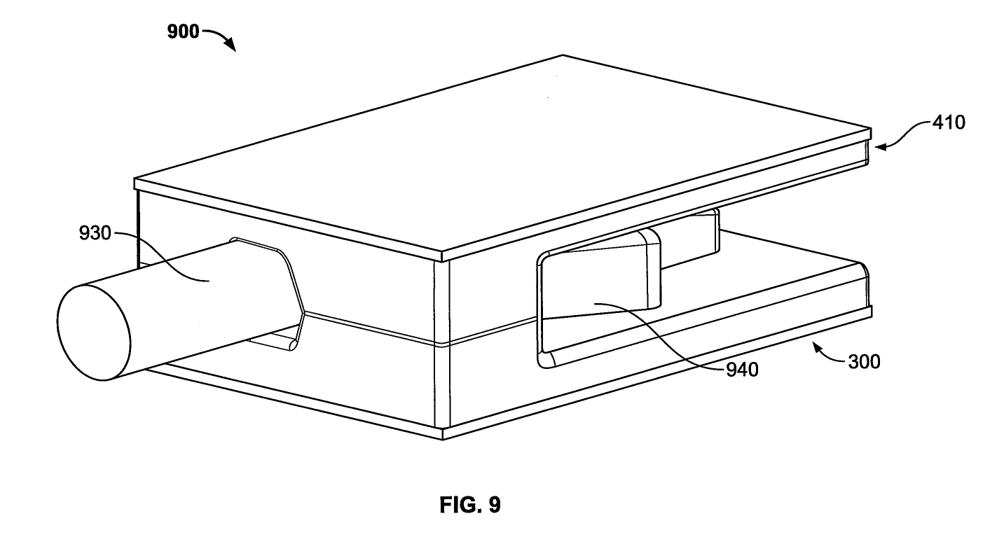

FIG. 9 illustrates a wrist 930 and hand 940 compressed between the upper and lower portions 410, 300 of a therapy housing 900 according to one embodiment of the present invention. The therapy housing 900 may capture the wrist 930 and hand 940 in compression. The wrist supports 350 may be positioned and configured so as to assist in preventing the patient's wrist 930 and hand 940 from slipping out of the therapy housing 900. As the upper and lower portions 410, 300 of the therapy housing 900 are compressed about the wrist 930 and hand 940, a space may exist only about the patient's carpal tunnel region such that minimal compression is exerted in this region.

FIG. 10 illustrates a rotated and compressed wrist 930 and hand 940 and a secured upper arm 1010 during use of a therapeutic system 1000 in accordance with one embodiment of the present invention. As shown, the therapeutic system 1000 may hold a patient's upper arm 1010 inline with his or her standing or seated body via an upper arm restraining device 1020. The upper arm restraining device 1020, which may prevent the patient's arm from moving forward, may contain a conforming foam and/or a pneumatic inflation bladder to cushion the upper arm 1010 during periods of decompressive tensile force application 1095. The upper arm restraining device 1020 may include a tension measuring device, such as, but not limited to, a load cell or load button that may feed information regarding the decompressive tensile force 1095 exerted at the wrist 1050 and hand 1060 locations back to the controller 485. Below the upper arm restraining device 1020, the elbow 1030 may be bent to or near 90 degrees, and extends the forearm 1040 towards the wrist 930 and hand 940. The wrist 1050 and hand 1060 are shown captured between the upper and lower portions 410, 300 of the therapy housing 900 and rotated outward 90 degrees. In one embodiment, the patient's hand 940 may be positioned so that the palm is facing the patient's body. As previously mentioned, the wrist supports 350 of the therapy housing 900 may keep the wrist 930 and hand 940 from slipping out from between the therapy housing 900 during periods of decompressive tensile force application 1095.

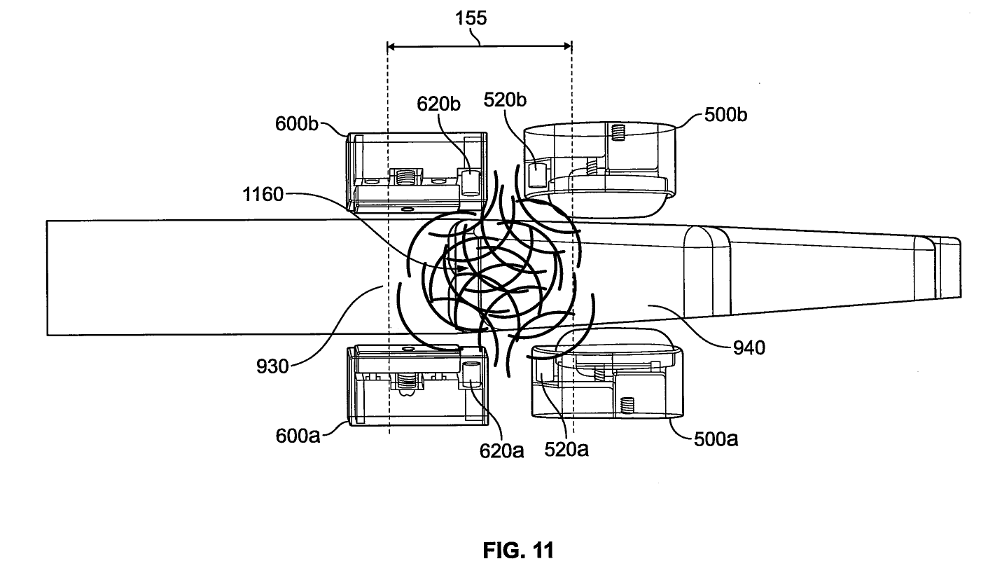

FIG. 11 is a top plan view of a wrist 930 and hand 940 positioned between the proximal and distal therapeutic devices 500a, 500b, 600a, 600b as they may be positioned within the therapy housing (not shown) according to one embodiment of the present invention. The lower proximal therapeutic device 600a is shown being positioned such that the plurality of light sources 620a are near the distal heads of the ulna and radius forearm bones and illuminate 1160 (shown as line arcs) the wrist 930 and carpal tunnel region 155. The distal therapeutic device 600b along the upper portion 410 may be positioned such that its plurality of light sources 620b are near the distal heads of the ulna and radius forearm bones 105, 110 and illuminate 1160 the wrist 930 and carpal tunnel region 155. The lower proximal therapeutic device 500a may be positioned such that its light therapy sources 520a are near the proximal heads of the metacarpal bones and illuminate 1160 the hand 940 and carpal tunnel region 155. The upper proximal therapeutic device 500b may be positioned such that its light therapy sources 520b are near the proximal heads of the metacarpal bones and illuminate 1160 the hand 940 and carpal tunnel region 155.

During periods of illumination by the proximal and distal therapeutic devices 500a, 500b, 600a, 600b, which may be applied during decompressive tensile force cycles, light therapy from all of the therapeutic devices 500a, 500b, 600a, 600b may substantially illuminate 1160 the carpal tunnel region 155.

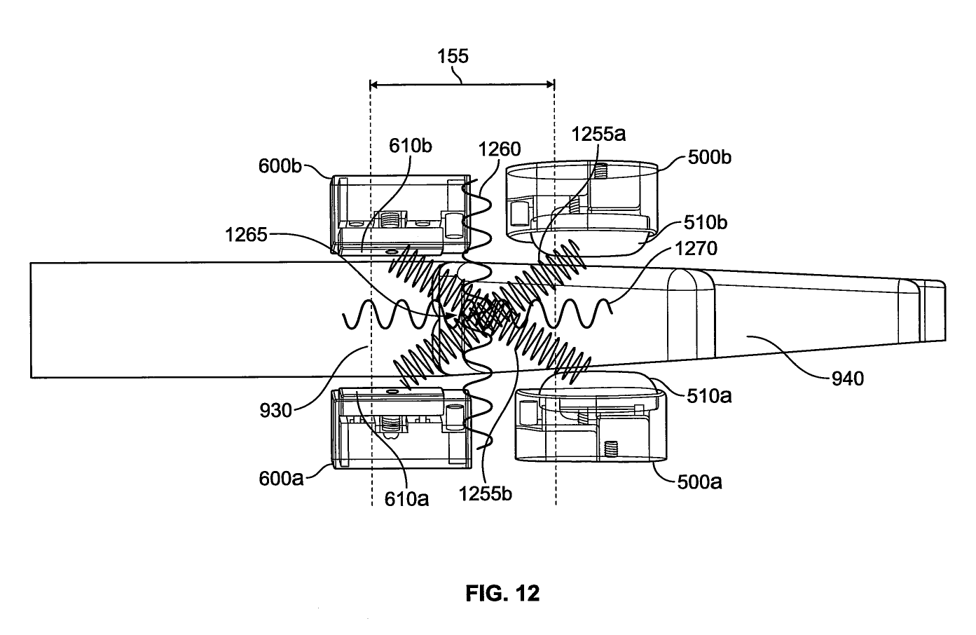

FIG. 12 is a top plan view of a wrist 930 and hand 940 undergoing Quadripolar Interferential stimulation while positioned between proximal and distal therapeutic devices 500a, 500b, 600a, 600b according to one embodiment of the present invention. The lower distal therapeutic device 600a may be positioned such that its electrode 610a is near the distal heads of the ulna and radius forearm bones. This electrode 610a may transmit a high frequency sine wave 1255a through the wrist 930 and carpal tunnel region 155 to the electrode 510b in the upper proximal therapeutic device 500b. The upper distal therapeutic device 600b may be positioned such that its electrode 610b is near the distal heads of the ulna and radius forearm bones. This electrode 610b may transmit a high frequency sine wave 1255b through the wrist 930 and carpal tunnel region 155 to the hand electrode 510a of the lower proximal therapeutic device 500a. The lower proximal therapeutic device 500a may be positioned such that its electrode 510a is near the proximal heads of the metacarpal bones. This electrode 510a may transmit a high frequency sine wave 1255b through the wrist 930 and carpal tunnel region 155 to the electrode 610b of the upper distal therapeutic device 600b. The upper proximal therapeutic device 500b may be positioned such that its electrode 510b is near the proximal heads of the metacarpal bones. This electrode 510b may transmit a high frequency sine wave 1255a through the wrist 930 and carpal tunnel region 155 to the electrode 610b of the lower distal therapeutic device 600a.

The two high frequency sine waves 1255a, 1255b transmitted through the carpal tunnel region 155 may be of different frequencies (e.g. 4000 Hz and 4250 Hz). Wherever the two waveforms 1255a, 1225b are present, for example at a crossing 1265 at the center of the carpal tunnel region in FIG. 12, interference may occur. Interference results in a waveform with low-frequency characteristics (a “beat frequency”) 1260, 1270, which radiates through and about the carpal tunnel region. 155.

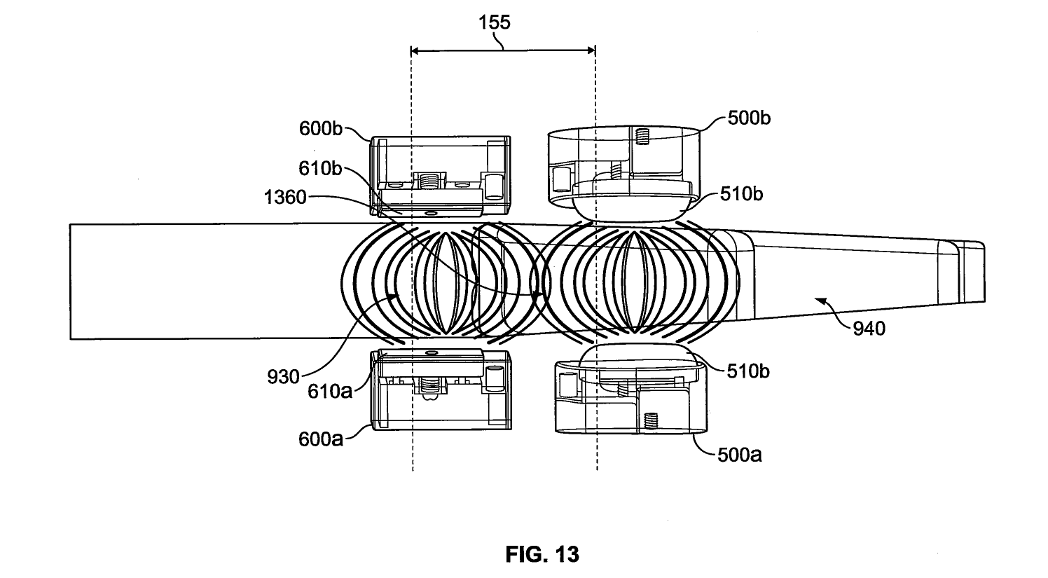

FIG. 13 is a top plan view of upper and lower proximal and distal therapeutic devices 500a, 500b, 600a, 600b positioned about a patient's wrist 930 and hand 940 that is undergoing Medium Frequency or Bipolar Interferential stimulation of the carpal tunnel region 155 according to one embodiment of the present invention. The lower distal therapeutic device 600a may be positioned such that its electrode 610a is near the distal heads of the ulna and radius forearm bones. The electrode 610a of the lower distal therapeutic device 600a may transmit a high frequency sine wave 1360 through the wrist 930 and carpal tunnel region 155 to the upper distal therapeutic device 600b. The upper distal therapeutic device 600b may be positioned such that its electrode 610b is near the distal heads of the ulna and radius forearm bones. The electrode 610b of the upper distal therapeutic device 600b may transmit a high frequency sine wave 1360 through the wrist 930 and carpal tunnel region 155 to the electrode 610a of the lower distal therapeutic device 600a. The lower proximal therapeutic device 500a may be positioned such that its electrode 510a is near the proximal heads of the metacarpal bones. The electrode 510 of the lower proximal therapeutic device 500a may transmit a high frequency sine wave 1360 through the wrist 930 and carpal tunnel region 155 to the upper proximal therapeutic device 500b. The upper proximal therapeutic device 500b may be positioned such that its electrode 510b is near the proximal heads of the metacarpal bones. The electrode 510b of the upper proximal therapeutic device 500b may transmit a high frequency sine wave 1360 through the wrist 930 and carpal tunnel region 155 to the lower proximal therapeutic device 500a.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A system for treating carpal tunnel syndrome comprising:
a. a therapy housing, the therapy housing including an upper portion and a lower portion, the therapy housing configured to encompass at least a portion of the hand of an individual;
b. at least one therapeutic device, the at least one therapeutic device configured to provided a treatment modality to the carpal tunnel region, the at least one therapeutic device being attached to the therapy housing; and
c. framework, the framework including at least one rail, the at least one rail operably connected to the upper portion and the lower portion of the therapy housing, the upper portion configured to be moved along at least a portion of the at least one rail.

2. The invention of claim 1 further comprising a rotation assembly, the rotation assembly being operably connected to the framework and configured to rotate the position of the framework approximately 90 degrees.

3. The invention of claim 2 further comprising a movable frame, the movable frame being operably connected to the therapy housing, the movable frame being configured to allow for the adjustment of the linear position of the therapy housing.

4. The invention of claim 3 further comprising a rotational motor, the rotational motor being configured to move the upper portion along at least a portion of the rail.

5. The invention of claim 4 further comprising a controller, the controller configured to control the operation of the rotational motor so as to control the position of the upper portion along the at least one rail.

6. The invention of claim 5 further comprising a mechanical scissors apparatus, the mechanical scissors apparatus being operably connected to both the upper portion and the rotational motor.

7. The invention of claim 1 further comprising a movable frame, the movable frame being operably connected to the therapy housing, the movable frame being configured to allow for the adjustment of the linear position of the therapy housing.

8. The invention of claim 1 further comprising a tension measuring device operably connected to the therapeutic housing, the tension measuring device configured to detect pressure exerted upon the hand and wrist when the hand and wrist are compressed between the upper portion and lower portion of the therapy housing.

9. The invention of claim 1 wherein the at least one therapeutic device includes an upper proximal therapeutic device and an upper distal therapeutic device connected to the upper portion, and a lower proximal therapeutic device and a lower distal therapeutic device connected to the lower portion.

10. The invention of claim 9 wherein the upper and lower proximal therapeutic devices and the upper and lower distal therapeutic devices include therapeutic modalities for providing light therapy and an electrode for providing electric stimulation therapy.

11. The invention of claim 1 further comprising an arm restraining device.

12. A system for treating carpal tunnel syndrome comprising:
a. a therapy housing, the therapy housing including an upper portion and a lower portion, the lower portion including a wrist support, a wrist channel, and a hand support region, the therapy housing configured to encompass at least a portion of a hand and a wrist of an individual;
b. at least one therapeutic device, the at least one therapeutic device configured to provided a treatment modality to the carpal tunnel region, the at least one therapeutic device being attached to the therapy housing;
c. a tension measuring device operably connected to the therapeutic housing, the tension measuring device configured to detect pressure exerted upon the hand and wrist when the hand and the wrist are compressed between the upper portion and lower portion of the therapy housing;
d. framework, the framework including at least one rail, the at least one rail operably connected to the upper portion and the lower portion of the therapy housing;
e. a rotational motor, the rotational motor operably connected to the upper portion to allow the upper portion to move along at least a portion of the rail;
f. a rotation assembly, the rotation assembly being operably connected to the framework, the rotation assembly being configured to rotate the position of the therapy housing approximately 90 degrees; and
g. a movable frame, the movable frame operably connected to the therapy housing, the movable frame being configured to allow for the adjustment of the linear position of the therapy housing.

13. The invention of claim 12 wherein the at least one therapeutic device includes an upper proximal therapeutic device and an upper distal therapeutic device connected to the upper portion and a lower proximal therapeutic device and a lower distal therapeutic device connected to the lower portion.

14. The invention of claim 13 wherein the upper and lower proximal therapeutic devices and the upper and lower distal therapeutic devices include therapeutic modalities for providing light therapy and an electrode for providing electric stimulation therapy.

15. The invention of claim 13 further comprising a controller, the controller configured to control the operation of the rotational motor so as to control the movement of the upper portion along the at least one rail.

16. The invention of claim 12 further comprising an arm restraining device.

17. The invention of claim 12 further comprising a mechanical scissors apparatus operably connected to the upper portion and the rotational motor.

18. The invention of claim 12 wherein the moveable frame includes a threaded mechanical screw, the threaded mechanical screw being operably connected to a second rotational motor, the second rotational motor being configured to rotate the threaded mechanical screw so as to adjust the linear position of the therapy housing.

19. A method of treating carpal tunnel syndrome comprising:
a. applying decompressive forces to a wrist;
b. applying light therapy to the wrist while the wrist is simultaneously subjected to decompressive forces; and
c. applying electrical stimulation to the wrist while the wrist is simultaneously subjected to light therapy and decompressive forces.

20. The method of claim 21, wherein said applying electrical stimulation comprises bipolar and quadripolar interferential electrical stimulation above, about, and below the carpal tunnel region.

21. A method of treating carpal tunnel syndrome comprising:
a. inserting at least a portion of a hand and wrist of a patient into a lower portion of a therapy housing;
b. lowering an upper portion of the therapy housing onto at least a portion of the hand to at least partially compress the hand;
c. applying light therapy to an affected area; and
d. applying electrical simulation to the affected area.

22. The method of claim 21, wherein said applying electrical stimulation comprises bipolar and quadripolar interferential electrical stimulation above, about, and below the carpal tunnel region.
